(19) United States
(12) Patent Application Publication
(10) Pub. No.: US 2012/0070703 A1
(43) Pub. Date: Mar. 22, 2012

(54) Battery Module

(75) Inventors: Thomas Wahl, Pforzheim (DE); Florian Wahl, Lohr (DE); Leonore Schwegler, Stuttgart (DE); Bernd Schumann, Rutesheim (DE)

(73) Assignee: ROBERT BOSCH GMBH, Stuttgart (DE)

(21) Appl. No.: 13/138,377

(22) PCT Filed: Dec. 15, 2009
(86) PCT No.: PCT/EP2009/067134

§ 371 Date: Nov. 23, 2011

(30) Foreign Application Priority Data
Feb. 6, 2009 (DE) 10 2009 000 660.5

(51) Int. Cl. H01M 2/12

(52) U.S. Cl. 429/53; 429/82

(57) ABSTRACT

The invention relates to a battery module, in particular for a motor vehicle. The battery module has a housing, at least one battery disposed in the housing, and at least one device for dissipating gases or vapors from the at least one battery. According to the invention, the at least one device has at least one element for precipitating at least one toxic and/or environmentally harmful material from the gases or vapors.

The present invention relates to a battery module according to the preamble to claims 1 and 11, a battery module system according to the preamble to claim 14, and a motor vehicle.

### PRIOR ART

Batteries such as lithium ion batteries or zebra batteries supply power to various devices such as those in motor vehicles, hospitals, or power drills. In general, several batteries are built into a housing and thus constitute a battery module. Battery modules have the advantage that they can be easily filled with a cooling fluid and permit higher electrical output to be implemented by combining a plurality of battery modules to form a battery module system.

In batteries such as lithium ion batteries, when malfunctions occur, for example in the event of a fire or a so-called thermal runaway, gases or vapors are produced that can result in excess pressure in the gas-tight housing of the battery. To prevent the battery from bursting, a pressure-relief valve vents the gases or vapors through a gas-venting line into the environment surrounding the battery. The emerging gases and vapor are usually very poisonous so that they can be harmful to the environment. In particular, they can disadvantageously constitute a hazard to human health.

### DISCLOSURE OF THE INVENTION

### Advantages of the Invention

A battery module according to the invention, in particular for a motor vehicle, includes a housing, at least one battery situated in the housing, and at least one device for conveying gases or vapors out of the at least one battery; the at least one device is provided with at least one means for separating out at least one poisonous and/or environmentally harmful substance from the gases or vapors. As a result, the poisonous or environmentally harmful substances are not released into the environment where they could be a threat to people because they are segregated or separated out before the gases or vapors are released. A battery module can also be a battery with at least one device for bleeding off gases or vapors from the at least one battery. In particular, the poisonous and/or environmentally harmful substances are a gas, gases, or vapor.

In another advantageous embodiment, the at least one means includes at least one adsorption material. The adsorption material can easily adsorb poisonous or environmentally harmful substances, thus providing a simple means for separating them out.

In one variant, the at least one adsorption material is activated charcoal and/or at least one inorganic adsorption material such as zeolites, aluminophosphate, or γ-aluminum oxide (γ-Al₂O₃).

In another embodiment, the specific surface area of the at least one adsorption material is greater than 50 m²/g, in particular greater than 100 m²/g.

Preferably, the at least one adsorption material is provided with compounds or substances with a polar atomic bond, e.g. ammines. This increases the adsorption capacity for polar gaseous compounds.

In a supplementary embodiment, the at least one device includes at least one gas-venting line and one pressure relief valve for each battery of which there is at least one, or one gas-venting line and one pressure relief valve for the entire battery module.

In another embodiment, an inside of the at least one gas-venting line is provided with the at least one adsorption material. It is therefore unnecessary to provide an additional component for accommodating the adsorption material because the adsorption material is accommodated on the inside of the gas-venting line that is provided anyway.

In a variant, the at least one gas-venting line feeds into a chamber through which gases or vapors are conveyed, adsorption material is accommodated in the chamber, and preferably, the volume per unit length of the chamber is greater than in the at least one gas-venting line. In a chamber that is completely filled with adsorption material, all of the gases or vapors must flow through the adsorption material so that the poisonous or environmentally harmful substances can be separated out particularly well, in particular completely or almost completely.

In a supplementary embodiment, the at least one gas-venting line is embodied as helical. This increases the length of the gas-venting line and therefore also increases its adsorption capacity.

In another embodiment, the at least one battery is situated in the housing in a fluid-tight fashion and/or the battery is a lithium ion battery.

A battery module according to the invention, in particular for a motor vehicle, includes a housing, at least one battery situated in the housing, and at least one device for conveying gases or vapors out of the at least one battery; the at least one device is provided with a collecting tank for storing gases or vapors.

The collecting tank is suitably filled with a vacuum before it is used to store the gases or vapors. In particular, the collecting tank can be connected in a fluid-tight fashion to the gas-venting line via a sealing mechanism such as a diaphragm or valve.

In an additional embodiment, the collecting tank for storing the gases or vapors can be pressurized to at least 1 bar, e.g. by means of a compressor.

In another embodiment, the at least one battery includes a positively charged electrode and a negatively charged electrode.

In one variant, the means is a processing system for separating out or burning off poisonous or environmentally harmful substances.

A battery module system according to the invention includes at least one battery module described in this application.

A motor vehicle according to the invention includes a battery module described in this application and/or a battery module system described in this application.

### BRIEF DESCRIPTION OF THE DRAWINGS

Three exemplary embodiments of the invention will be explained in greater detail below in conjunction with the accompanying drawings.

FIG. 1 is a schematic cross section through a first embodiment of a battery module,

FIG. 2 shows a second embodiment of the battery module according to FIG. 1,

FIG. 3 shows a third embodiment of the battery module according to FIG. 1,

FIG. 4 is a longitudinal section through a battery module system, and

FIG. 5 is a very schematic view of a motor vehicle.

### EMBODIMENTS OF THE INVENTION

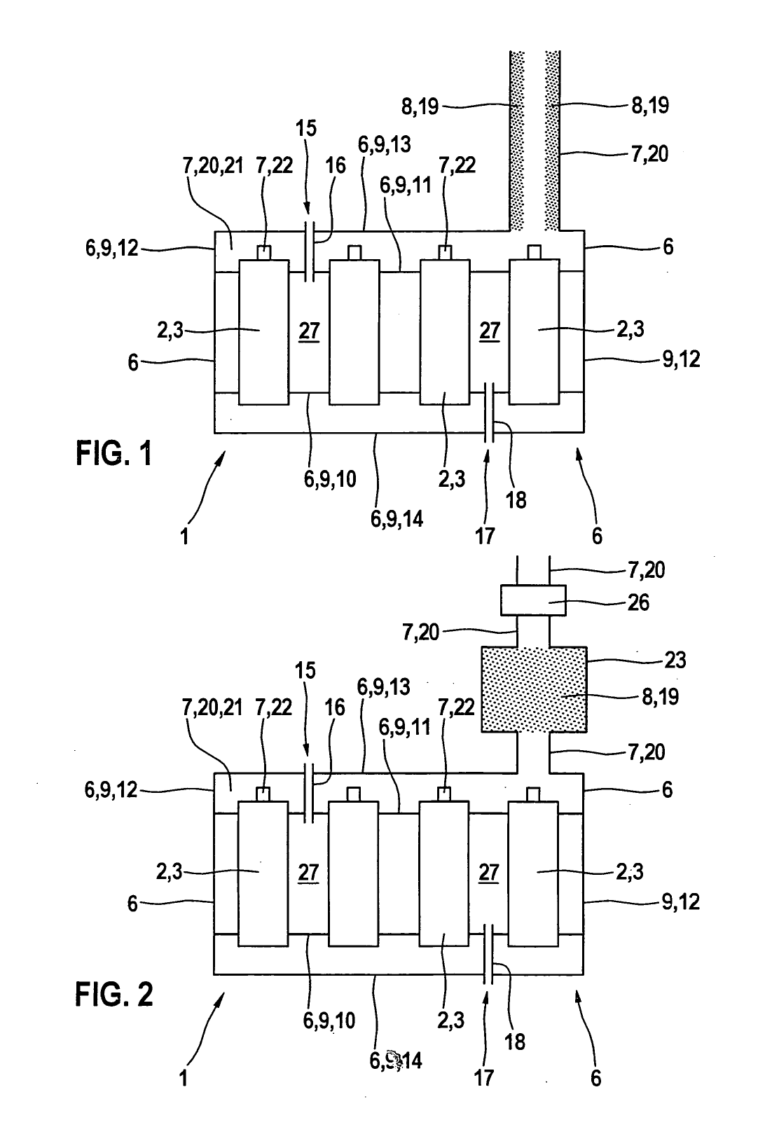

FIG. 1 is a schematic cross section through a battery module 1 according to the invention for accommodating eight batteries 2 embodied in the form of lithium ion batteries 3. A housing 6 composed of walls 9 has a total of four side walls 12, a bottom wall 10, and a top wall 11 (FIGS. 1 through 3). The battery module is 12 cm long, 7 cm wide, and 10 cm high. Air functioning as a cooling fluid is conveyed into an interior 27 of the housing 6 through an inlet opening 15 of an inlet line 16 in the top wall 11. An outlet line 18 with an outlet opening 17 is analogously situated in the bottom wall 10. The housing 6 is composed of metal or plastic. A blower or fan (not shown) conveys the air into the inlet opening 15 of the inlet line 16, causing it to flow into the interior 27 at the end of the inlet line 16. The air conveyed into the housing 6 flows back out of the housing at the end of the outlet line 18.

In the event of malfunctions, particularly in the event of a fire, gases or vapors can be generated in the lithium ion batteries 3. To prevent the lithium ion batteries 3 from leaking or exploding, once a particular pressure in the batteries 2 is reached, a pressure relief valve 22 on the batteries 2 conveys the gases or vapors into a collecting chamber 21. The collecting chamber 21 is composed of a top wall 13, a part of the side wall 12, and the top wall 11 and constitutes a gas-venting line 20 because the gases and vapors are also conveyed out through the collecting chamber 21 (FIGS. 1 through 3). The bottom wall 10 and top wall 11 are provided with eight circular recesses in which the eight lithium-ion batteries 3 are situated (not shown). Below the bottom wall 10, a lower bottom wall 14 is provided. The interior 27 through which the cooling fluid is conveyed is thus sealed off from the collecting chamber 21 in a fluid-tight manner. The collecting chamber 21 feeds into the gas-venting line 20 for conveying the gases or vapors into the surroundings or the environment. The gas-venting line 20, the collecting chamber 21, and the pressure relief valve 22 thus constitute devices 7 for conveying gases or vapors out of the batteries 2.

FIG. 1 shows a first exemplary embodiment for a means 8 for separating out poisonous or environmentally harmful substances from the gases or vapors. An inside of the gas-venting line 20 is provided with activated charcoal as an adsorption material 19. The activated charcoal adsorbs poisonous or environmentally harmful substances from the gases emerging from the batteries 2 before they are released into the surroundings so that these poisonous substances cannot pose a danger to the environment. In the event of an excess pressure in at least one battery 2, at least one pressure relief valve 22 opens. The gases or vapors flow out of the at least one battery 2 through the pressure relief valve 22 into the collecting chamber 21 and from the collecting chamber 21 through the gas-venting line 20 into the environment. As the gases or vapors flow through the gas-venting line 20, the adsorption material 19 adsorbs the poisonous substances so that no poisonous substances or almost none of them escape into the environment.

In a second exemplary embodiment, a chamber 23 is used as a means 8 for separating out poisonous or environmentally harmful substances from the gases or vapors (FIG. 2). The chamber 23 is a component of the gas-venting line 20 so that the gases and vapors flow through the chamber 23. For this purpose, the chamber 23 has a first opening for conveying the gases or vapors out of the gas-venting line 20 into the chamber 23 and a second opening for conveying the gases or vapors out of the chamber 23 into the gas-venting line 20. The chamber 23 is filled, preferably completely, with the adsorption material 19. For example, zeolites and/or activated charcoal can be used as the adsorption material 19, which is provided with compounds or substances with a polar atomic bond, e.g. ammines, in order to increase the adsorption capacity for polar gaseous compounds or substances. A check valve 26 in the gas-venting line 20 situated after the chamber 23 in the flow direction prevents gases, fluids, or solids from traveling from outside into the gas-venting line 20 and therefore into the battery module 1. The check valve 26 opens at an excess pressure of at least 350 mbar in the gas-venting line 20 relative to the environment. This corresponds to an excess pressure that occurs when there is a temperature increase of 100 K in the battery module 1 relative to an outside temperature of 20° C. Preferably, the check valve 26 should not open in response to pressure fluctuations that occur due to normal temperature or pressure fluctuations.

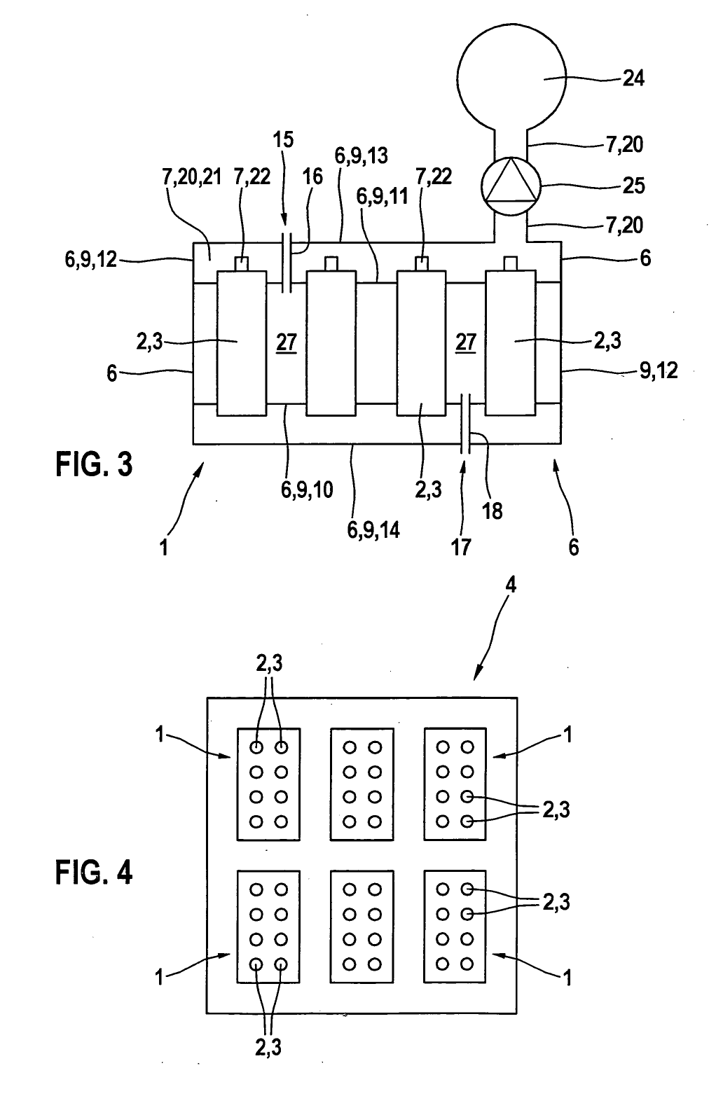

FIG. 3 shows a third exemplary embodiment. The gases or vapors conveyed through the gas-venting line 20 are collected or stored by a collecting tank 24 so that they do not escape into the environment. A compressor 25 increases the pressure in the collecting tank 24 to a range of between 2 and 20 bar in order to be able to store a larger quantity of gases or vapors in the collecting tank 24 per unit volume. After the introduction of the gases or vapors into the collecting tank 24, a sensor, not shown, can monitor the gas or the vapors in the collecting tank 24 and then a control unit (not shown) can emit a corresponding signal. The gases or vapors in the collecting tank 24 can subsequently be disposed of without harm to the environment. The collecting tank 24 can also be embodied in the form of an elastic balloon.

In a fourth exemplary embodiment that is not shown, the collecting tank 24 is filled with a vacuum before it is used to store gases or vapors. The gas-venting line 20, which conveys the gases or vapors from the collecting chamber 21 to the collecting tank 24, contains a diaphragm. The pressure relief valves 22 are equipped with sensors that detect an opening of a pressure relief valve 22. When a pressure relief valve 22 opens, a signal announcing the opening is sent to a control unit, which triggers the splitting of the diaphragm, e.g. mechanically or electrically, through a heating and melting of the diaphragm by conveying current through the diaphragm. Because of the vacuum in the collecting tank 24, the gases or vapors are sucked out of the collecting chamber 21.

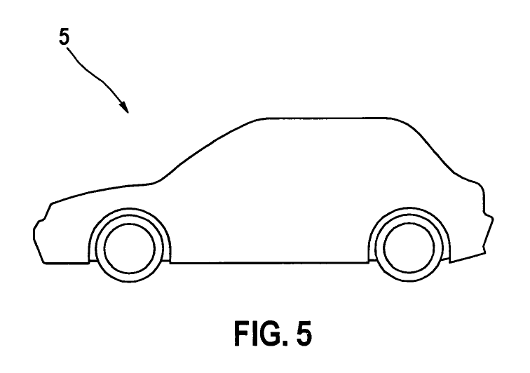

It is also possible to connect a plurality of battery modules 1 to form a battery module system 4 according to the invention (FIG. 4). The inlet openings 15 and outlet openings 17 of the individual battery modules 1 are connected in parallel (not shown) to a central air supply such as a fan. In a battery module system, for example for a motor vehicle 5, containing 6 battery modules 1 with 8 lithium-ion batteries 3 each, there are thus a total of 48 lithium-ion batteries 3. The modular construction permits better scalability because various electrical outputs can be implemented for various applications using the same identical battery modules 1.

Provided that nothing to the contrary is stated here, the details of the various exemplary embodiments can be combined with one another.

Considered as a whole, the battery module 1 according to the invention has significant advantages. The gases or vapors containing poisonous or environmentally harmful substances that escape from the batteries 2 in when a malfunction occurs are no longer released into the environment so that they no longer pose a threat to people.

1-15. (canceled)

16. A battery module, in particular for a motor vehicle, including:
a housing;
at least one battery situated in the housing; and
at least one device for conveying gases or vapors out of the at least one battery,
wherein the at least one device is provided with at least one element for separating out at least one poisonous and/or environmentally harmful substance from the gases or vapors.

17. The battery module as recited in claim 16, wherein the at least one element includes at least one adsorption material.

18. The battery module as recited in claim 17, wherein the at least one adsorption material is activated charcoal and/or at least one inorganic adsorption material such as zeolites, aluminophosphate, or γ-aluminum oxide.

19. The battery module as recited in claim 17, wherein the specific surface area of the at least one adsorption material is greater than 50 m²/g, in particular greater than 100 m²/g.

20. The battery module as recited in claim 18, wherein the specific surface area of the at least one adsorption material is greater than 50 m²/g, in particular greater than 100 m²/g.

21. The battery module as recited in claim 17, wherein the at least one adsorption material is provided with compounds or substances with a polar atomic bond, e.g. ammines.

22. The battery module as recited in claim 20, wherein the at least one adsorption material is provided with compounds or substances with a polar atomic bond, e.g. ammines.

23. The battery module as recited in claim 17, wherein the at least one device includes at least one gas-venting line and one pressure relief valve for each battery of which there is at least one.

24. The battery module as recited in claim 22, wherein the at least one device includes at least one gas-venting line and one pressure relief valve for each battery of which there is at least one.

25. The battery module as recited in claim 23, wherein an inside of the at least one gas-venting line is provided with the at least one adsorption material.

26. The battery module as recited in claim 23, wherein the at least one gas-venting line feeds into a chamber through which gases or vapors are conveyed, adsorption material is accommodated in the chamber, and a volume per unit length of the chamber is greater than in the at least one gas-venting line.

27. The battery module as recited in claim 24, wherein the at least one gas-venting line feeds into a chamber through which gases or vapors are conveyed, adsorption material is accommodated in the chamber, and a volume per unit length of the chamber is greater than in the at least one gas-venting line.

28. The battery module as recited in claim 23, wherein the at least one gas-venting line is embodied as helical.

29. The battery module as recited in claim 16, wherein the at least one battery is situated in the housing in a fluid-tight fashion and/or the battery is a lithium ion battery.

30. A battery module, in particular for a motor vehicle, including:
a housing;
at least one battery situated in the housing; and
at least one device for conveying gases or vapors out of the at least one battery,
wherein the at least one device is provided with a collecting tank for storing the gases or vapors.

31. The battery module as recited in claim 30, wherein the collecting tank is suitably filled with a vacuum before it is used to store the gases or vapors.

32. The battery module as recited in claim 30, wherein it is possible to pressurize the collecting tank for storing the gases or vapors to at least 1 bar, e.g. by means of a compressor.

33. A battery module system having a plurality of battery modules, wherein the battery module system includes at least one battery module as recited in claim 16.

34. A motor vehicle, having a battery module system as recited in claim 33.

35. A motor vehicle, having a battery module as recited in claim 16.
